(19) United States
(12) Patent Application Publication
(10) Pub. No.: US 2006/0045301 A1
(43) Pub. Date: Mar. 2, 2006

(54) Speaker enclosure with a liquid chamber for mounting a speaker driver

(76) Inventor: Frank J. Jakubaitis, Tustin, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/932,853

(22) Filed: Sep. 2, 2004

(51) Int. Cl. H04R 25/00

(52) U.S. Cl. 381/345; 381/182

(57) ABSTRACT

Disclosed is a speaker including a speaker enclosure having a liquid chamber to mount and enclose a speaker driver. The speaker enclosure includes a front mounting portion and a body portion. The front mounting portion has an opening to mount the speaker driver and the body portion extends rearwardly from the mounting portion and the speaker driver is enclosed by the front mounting portion and the body portion within an interior of the speaker enclosure. Particularly, the body portion includes a liquid chamber that may be filled with a liquid to affect the tuning of the speaker enclosure to enhance lower frequencies.

### BACKGROUND

1. Field of the Invention

This invention relates to speaker enclosures. In particular, the invention relates to a speaker enclosure with a liquid chamber for mounting a speaker driver.

2. Description of Related Art

A speaker driver is an electric acoustic transducer that converts alternating electric currents into sound waves with the same frequency characteristics and wave-forms that are within the range of human hearing (approximately 16 Hz to 20 KHz). In particular, a speaker driver typically includes a coil of wire, called a voice coil, which is held in the field of a magnet. When alternating currents flow in the coil, a changing magnetic field is produced around the coil. This field interacts with the field from the magnet to produce reciprocal forces on the coil. The coil is mounted so that it can move as these forces occur. The coil is typically physically attached to a cone shaped diaphragm, which vibrates along with the coil. The moving diaphragm produces sound waves in the air.

The speaker driver is typically mounted within a speaker enclosure. The term speaker generally refers to the speaker having a speaker driver mounted within it. The speaker enclosure may be large or small resulting in a large or small speaker, respectively. Typically, the bigger the speaker enclosure, the bigger and the more robust the sound is generated from the speaker.

However, many potential speaker customers reside in living areas with a limited amount of space that can be dedicated for the use and placement of speakers. Therefore, many potential speaker customers are looking for small compact speakers that still provide the same big, robust, high-fidelity sound that is typically associated with big speakers, but without requiring the amount of space that needs to be dedicated to a big speaker.

Typically, speakers, and particularly small speakers, such as book-shelf speakers, have a speaker enclosure that is made out of a hard wood such as maple or oak. After the speaker driver is mounted in the small speaker enclosure, the speaker enclosure is stuffed with insulation material such as fabric or cloth (often called “box stuffing”). This box stuffing is inserted within the speaker enclosure to absorb sound waves in order to attempt to mitigate the “boxy sound” that occurs with the use of small speakers.

Nonetheless, even with the box stuffing inserted in the small speaker enclosure, small speakers still generally sound “boxy”. Further, by putting box stuffing within the speaker enclosure, although some of the boxy sound may be eliminated, the box stuffing unfortunately negatively affects the natural harmonics of the speaker driver thereby resulting in a lower quality sound emanating from the speaker. Also, in small speakers, a hole or port is typically made within the speaker enclosure in order to attempt to increase the amount of low frequency or bass sound that emanates from the speaker, which is already limited due to the small size of the speaker enclosure.

Unfortunately, even with these adjustments, today's small speakers are inadequate to satisfy the high-fidelity tastes of many potential speaker customers. Particularly, the combination of the “boxy sound,” the degradation of the natural harmonics of the speaker driver by the box stuffing, and the inadequate low frequency bass sound results in most potential speaker customers being dissatisfied with small speakers.

### SUMMARY

Embodiments of the invention relate to a speaker enclosure with a liquid chamber for mounting a speaker driver

In one aspect, the invention may be regarded as a speaker enclosure to mount and enclose a speaker driver, in which the speaker enclosure includes a front mounting portion and a body portion. The front mounting portion has an opening to mount the speaker driver. The body portion extends rearwardly from the mounting portion and the speaker driver is enclosed by the front mounting portion and the body portion within an interior of the speaker enclosure. Particularly, the body portion includes a liquid chamber. The liquid chamber may be filled with a liquid to affect the tuning of the speaker enclosure and to enhance lower frequencies.

In one embodiment, at least one baffle extends from the body portion into the interior of the speaker enclosure to aid in transmitting sound waves from the speaker driver to the liquid chamber and to enhance lower frequencies. The amount of liquid included in the liquid chamber may be pre-determined during a testing phase in order to affect the desired tuning of the speaker enclosure in combination with the speaker driver and to enhance lower frequencies. For example, the liquid may be a gelatinous material, such as a hair gel.

In one embodiment, the front mounting portion and the body portion of the speaker enclosure may be made from an acrylic material. Also, the speaker driver may be gasket mounted within the opening of the front mounting portion with a gasket such that the speaker enclosure may be pressurized.

By utilizing a speaker enclosure having a liquid chamber that includes a pre-determined amount of liquid, in conjunction with one or more baffles within the interior of the speaker enclosure, the overall speaker can be optimally tuned such that the natural harmonics of the speaker drivers are preserved and lower frequencies or bass sounds are amplified. This results in a small speaker having high-fidelity characteristics, including great bass sound, commonly associated with large speakers.

### BRIEF DESCRIPTION OF THE DRAWINGS

FIG. 1 is a perspective and cut-away view of a speaker or speaker system, according to one embodiment of the invention.

FIG. 2A is a perspective view of two speakers in a stacked formation.

FIG. 2B is a perspective view of two speakers mounted back-to-back.

FIG. 3 is a perspective view showing a speaker placed on a stand.

### DETAILED DESCRIPTION

In the following description, the various embodiments of the present invention will be described in detail. However, such details are included to facilitate understanding of the invention and to describe exemplary embodiments for implementing the invention. Such details should not be used to limit the invention to the particular embodiments described because other variations and embodiments are possible while staying within the scope of the invention. Furthermore, although numerous details are set forth in order to provide a thorough understanding of the present invention, it will be apparent to one skilled in the art that these specific details are not required in order to practice the present invention. In other instances details such as, well-known methods, components, processes, interfaces, electrical structures, circuits, etc. are not described in detail, or are shown in block diagram form, in order not to obscure the present invention.

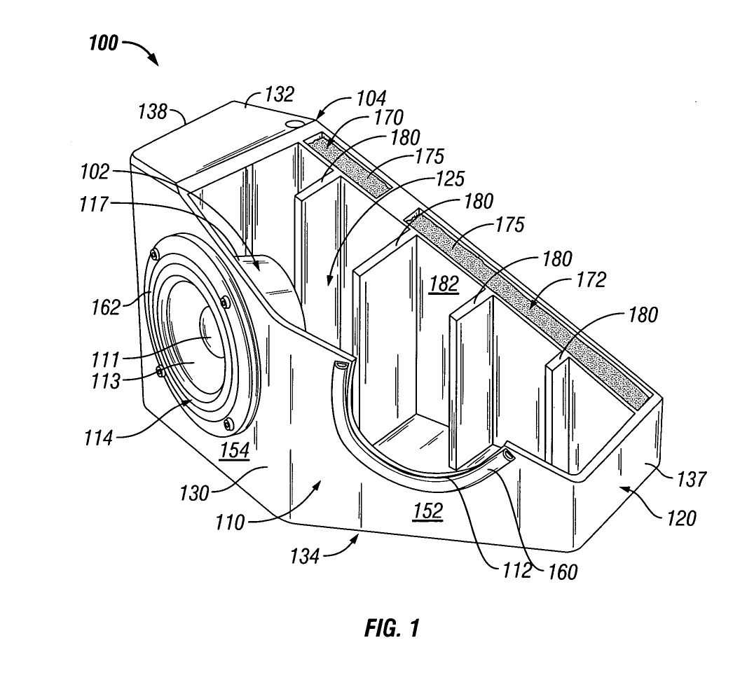

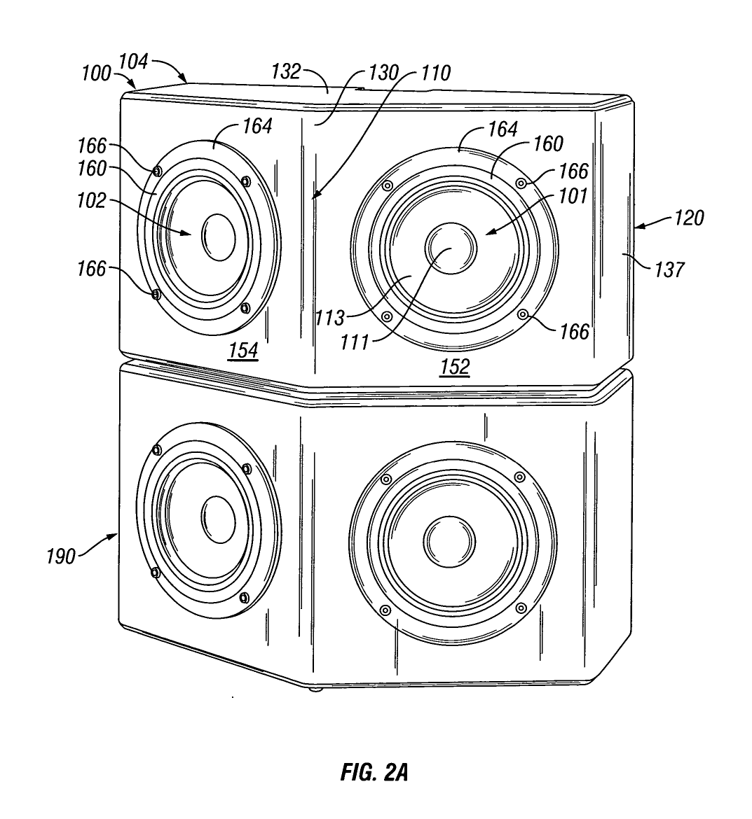

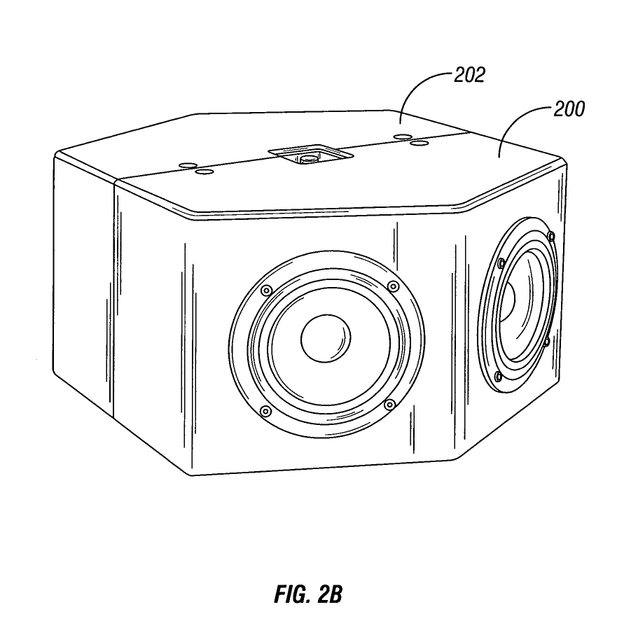

With reference to FIG. 1, which is a perspective and cut-away view of a speaker or speaker system, according to one embodiment of the invention, FIG. 1 shows a speaker 100 including a pair of speaker drivers 102 (only one shown) and a speaker enclosure 104 to mount the speaker drivers. As will be discussed, the speaker enclosure or speaker housing 104 includes a liquid chamber to affect the tuning of the speaker enclosure 104 and to enhance lower frequencies. Further, to aid in the following description, reference can also be to FIG. 2A, which shows a perspective view of two speakers 100 and 190 in a stacked formation.

Particularly, the speaker enclosure 104 includes a front mounting portion 110 having a first opening 112 to mount a first speaker driver 101 and a second opening 114 to mount a second speaker driver 102.

Further, the speaker enclosure 104 includes a body portion 120 that extends rearwardly from the front mounting portion 110. As shown in FIG. 1, the speaker driver 102 is enclosed by the front mounting portion 110 and the body portion 120 within an interior 125 of the speaker enclosure 104.

In one embodiment, the front mounting portion 110 comprises a front wall 130 that includes openings 112 and 114 in which respective speaker drivers 101 and 102 are mounted. Particularly, in one embodiment, the body portion 120 extends rearwardly from the front mounting portion 110 and includes a top wall 132 and a bottom wall 134 that extend rearwardly from the front mounting wall 130. Further, the body portion 120 includes a pair of opposed side walls 137 and 138 that extend rearwardly from the front mounting wall 130 between the top and bottom walls 132 and 134 to a rear wall 140. Thus, the body portion 120 is comprised of opposed top and bottom walls 132 and 134, opposed side walls 137 and 138, and a rear wall 140.

As can be seen in FIGS. 1 and 2A, the speaker drivers 101 and 102 are completely enclosed by the front, top, bottom, and side walls within the interior 125 of the speaker enclosure 104.

In one embodiment, the front mounting wall 130 may be of a semi-isobaric configuration in which a first section 152 of the front mounting wall is disposed at an approximately 45 degree angle relative to a second section 154 of the front mounting wall. In this embodiment, the first section 152 of the front mounting wall includes the first opening 112 for mounting the first speaker driver 101 and the second section 154 of the front mounting wall includes a second opening 114 for mounting the second speaker driver 102.

Also, it should be noted in FIGS. 1 and 2A that the speaker drivers 101 and 102 may be gasket mounted in their respective openings 112 and 114 by respective gaskets 160 and 162. For example, gasket 160 may be affixed about the first opening 112 of the first section 152 of the front mounting wall 130. Similarly, gasket 162 may be affixed about the second opening 114 of the second section 154 of the front mounting wall 130. Also, each of the speaker drivers 101 and 102 are respectively mounted to the front mounting wall 130 of the speaker housing 104 by annular face-plates 164 and fasteners 166. Because the speaker drivers 101 and 102 are gasket mounted to the speaker enclosure 104, the speaker enclosure may be pressurized.

It should be noted that the speaker enclosure 104 according to embodiments of the invention may be utilized with any number of suitable speaker drivers. Suitable speaker drivers may include a diaphragm 111, a dust cap 113, and a component housing 117 to house standard speaker driver electronic components. Further, any suitable methods of mounting the speaker driver 102 to the speaker enclosure 104 may be employed. In one embodiment, the speaker driver utilized may be a VIFA speaker driver manufactured by Danish Sound Technology. Particular technical details related to the VIFA speaker drivers will be discussed later. However, it should be appreciated that any type of suitable speaker driver may be utilized and mounted within speaker enclosure 104.

Also, it should be appreciated that although FIG. 1 and FIG. 2A show a speaker enclosure 104 utilizing two speaker drivers 101 and 102 that one, three, four, etc. or any suitable number of speaker drivers may be utilized with speaker housing 104, according to embodiments of the invention.

Additionally, in one embodiment, the speaker enclosure 104 including the front wall 130, opposed side walls 137 and 138, top and bottom walls 132 and 134, and rear wall 140, as well as the other components of the speaker enclosure 104, may be made from an acrylic material such as an acrylic fiber. Alternatively, the speaker enclosure 104 may be made from other types of material, such as wood, which may or may not include acrylic material.

In one embodiment, the speaker enclosure 104 may include a liquid chamber. As an example, as shown in FIG. 1, in one embodiment, the rear wall 140 may include two separate liquid chambers 170 and 172. In this example, the liquid chambers 170 and 172 of the rear wall 140 are rectangular and occupy most of the width and length of the rear wall. The liquid chambers 170 and 172 of the rear wall 140 of the speaker enclosure 104 may include a liquid 175 to affect the tuning of the speaker enclosure 104. Any sort of liquid may be utilized. However, in one embodiment, a gelatinous material such as a hair gel may be utilized as liquid 175.

The speaker enclosure 104 also includes a plurality of baffles 180 that extend from the interior surface 182 of the rear wall 140 into the interior 125 of the speaker enclosure 104 towards the speaker drivers 101 and 102. The baffles 180 aid in transmitting sound waves from the speaker drivers 102 to the liquid 175 of the liquid chambers 170 and 172 to enhance lower frequency bass sounds. It should be appreciated that the baffles are suitably sized to fit within the interior 125 of the speaker enclosure 104 and that any number of baffles 180 may be utilized dependent upon design considerations. Likewise, any number of liquid chambers may be utilized not only in the rear wall, but in other portions of the speaker enclosure 104 as well.

Typically, the amount of liquid 175 to be included in the liquid chambers 170 and 172 is pre-determined during a testing phase in order to affect a desired tuning of the speaker enclosure 104, in combination with the speaker drivers 101 and 102, in order to optimally tune the speaker 100 for the best high-fidelity sound and to enhance lower frequency or bass sound. Particularly, each speaker 100 may be individually tested and tuned and a particular amount of liquid 175 for each speaker may be determined and added to the speaker enclosure 104 in order to optimally tune the individual speaker.

Alternatively, based on statistical analysis, for a given set of speaker enclosures and speaker drivers, a particular amount of liquid 175 may be statistically determined to optimally tune a given set of speakers, and this pre-determined amount of liquid may be added to each speaker enclosure during the manufacturing process, instead of individually determining an amount of liquid for each individual speaker.

By utilizing a speaker enclosure 104 having liquid chambers 170 and 172 that include a pre-determined amount of liquid, in conjunction with one or more baffles 180 within the interior 125 of the speaker enclosure 104, the overall speaker 100 can be optimally tuned such that the natural harmonics of the speaker drivers 101 and 102 are preserved and lower frequency or bass sounds are amplified. This results in a small speaker having high-fidelity characteristics, including great bass sound, commonly associated with large speakers. Further, there is no need for box stuffing and the speaker can be pressurized (i.e. it does not require a hole or port) and thus even better sound characteristics can be created.

More particularly, speaker 100 has an excellent bass response due to the internal tuned radial baffles 180 that extend from the interior surface 182 of the rear wall 140 into the interior 125 of the speaker enclosure 104. The baffles 180 increase the internal surface area of the speaker and thereby amplify lower frequencies emanating from the speaker drivers 101 and 102.

Additionally, the liquid chambers 170 and 172 may include a pre-determined amount of liquid 175 to provide for overall speaker tuning and to further provide the speaker drivers 101 and 102 with a harmonically preserved environment. This overall design eliminates the need to add box stuffing into the enclosure. Also, as previously discussed, the speaker drivers 101 and 102 may be mounted with pressurized gaskets 164 to minimize sympathetic speaker vibrations. The speaker enclosure 104 may further be isolated from its environment by rubber feet (not shown).

The unique method of utilizing liquid to affect the tuning of the speaker enclosure 104 implements the Hemholz theory. The Hemholz theory characterizes the physical phenomenon that is most typically explained by the example of: when a level of liquid in a bottle is changed and struck, the bottle produces different tones dependent upon the amount of liquid in the bottle.

The Hemholz theory is implemented in the speaker enclosure 104 according to embodiments of the present invention by utilizing liquid 175 in the liquid chambers 170 and 172 allowing for variants of resonant tones by changing the amount of liquid; without changing the size or shape of the enclosure. Further, the use of liquid 175 in the liquid chambers 170 and 172 provides a further benefit by increasing the internal volume of area, which further enhances low frequency performance or bass sound. Those frequencies travel through the liquid easily and are often amplified by it. Moreover, higher frequencies are dissipated and absorbed thereby equalizing the low end to the more easily produced mid-high spectrum. The use of liquid in the enclosure 104 results in a highly efficient speaker enclosure with a small space footprint.

Thus, as previously discussed, by utilizing a speaker enclosure 104 having liquid chambers with a pre-determined amount of liquid, in conjunction with tuned baffles 180 within the interior 125 of the speaker enclosure 104, the overall speaker 100 is optimally tuned such that the natural harmonics of the speaker drivers are preserved and the lower frequency bass sounds are amplified by the combination of the baffles and liquid. This results in a small speaker having high-fidelity characteristics, including great bass sound, that is commonly only associated with large speakers.

Turning particularly to FIG. 2A, the speakers 100 and 190 as shown in FIG. 2A may be stacked upon one another for increased sound. Particularly, in this configuration they may be set within a corner of a room. The semi-isobaric configuration of the speakers in which the first section 152 of the mounting wall 130 is disposed at an approximately 45 degree angle relative to the second section 154 of the mounting wall 130 provides a design that maximizes the sonic quality of the speakers within a room.

Particularly, when the speaker 100 is put at a 90 degree angle in a corner of a room, speaker driver 101 of the first section 154 will resonate off of an adjacent wall of the room whereas speaker driver 102 of the second section of adjacent walls will resonate off another adjacent wall of the room. This further enhances the already increased bass sound of the speaker because now the bass resonates off of the adjacent wall of the room.

Turning briefly to FIG. 2B, FIG. 2B is a perspective view of two speakers 200 and 202 mounted back-to-back. It should be appreciated that the speakers 200 and 202 are constructed in accordance with the embodiments of the previously-described invention. In this configuration, the speakers provide sound in a 360 degree radius.

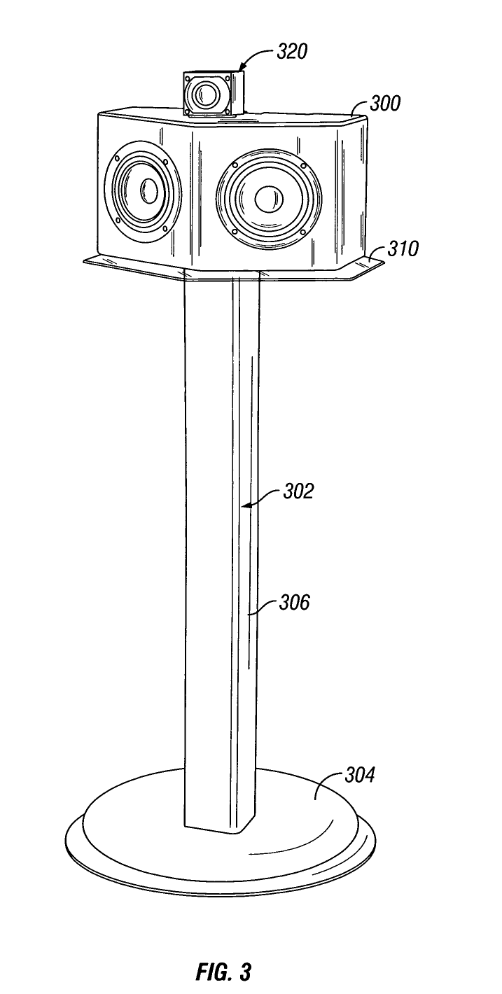

Turning now to FIG. 3, FIG. 3 is a perspective view showing a speaker 300 constructed in accordance with the embodiments of the present invention as previously-described placed on a stand 302. The stand 302 includes a circular base 304, a shaft 306 extending perpendicularly from the circular base 304, and a speaker placement section 310 perpendicular to the shaft 306 and parallel to the bass 304. The speaker placement section 310 is sized to accommodate the isobaric design of the speaker 300 and to support speaker 300.

By utilizing the stand 302, the speaker 300 can be placed at an elevated position in a room to further enhance the sonic quality of the speaker 300 to a listener in the room. Further, a tweeter 320 may be placed on top of speaker 300 to enhance high-frequency sound. Accordingly, the combination of the speaker 300, which has an excellent bass response in a small speaker, may further be enhanced with a small tweeter 320 having an excellent high-frequency response.

As previously discussed, the speaker 300, alone or in combination with tweeter 320, by utilizing a liquid chamber having a pre-determined amount of liquid, in conjunction with tuned baffles within the interior of the speaker 300, provides a speaker that is optimally tuned such that the natural harmonics of the speaker drivers are preserved and bass sounds are amplified. This results in a speaker with a small footprint having high-fidelity characteristics including a strong bass sound, characteristics that are commonly only associated with large speakers.

Briefly, some of the technical characteristics of the speaker 100, speaker drivers 101 and 102, and tweeter 320 will be briefly summarized below.

The following technical specifications apply to previously-described speaker 100, according to embodiments of the invention, including speaker enclosure 104 and the speaker drivers 101 and 102:

| | |
|---|---|
| Sensitivity | (2.83 V @ 1 m): 90 dB |
| Frequency Response | 55 Hz - 20 K Hz (−6 dB) |
| Impedance | 16 ohms |
| Power rating | 200 watts RMS (maximum recommended |
| | amplified power) |
| Transducers | Dual 5.25″ Vifa specially designed drivers |
| Energy dispersion | Twenty percent (20%) by reflection |
| | (corner placement) |
| | Eighty percent (80%) by direct radiation |
| Weight | 12 lbs. |
| Dimensions | 8.5″ h × 15″ w × 8.25″ d |
| | 33 cm × 21.6 cm × 12.7 cm |
| Construction | 25″ Acrylic |
| Extender Module | High frequency extender module: 1″ pure |
| | titanium dome |

As to the speaker drivers 101 and 102, these may be VIFA speaker drivers produced by Danish Sound Technology and the speaker driver technical characteristics may be summarized below:

| Nominal impedance [ohm] | 8 ohms |
|---|---|
| Voice coil resistance [ohm] | 5.6 ohms |
| Nominal poser [W] | 100 |
| Short term max power [W] | 350 |
| Operating Power [W] | 6.3 |
| Sensitivity [dB] | 90 |
| Frequency range [Hz] | 54-5000 |
| Free air resonance [Hz] | 54 |
| Voice coil diameter [mm] | 25 |
| Voice coil height [mm] | 10 |
| Air gap height [mm] | 6 |
| Voice coil inductance [mH] | 0.7 |
| Eff. Diaphragm Area [cm²] | 80 |
| Moving mass [g] | 6.5 |
| Magnet weight [g]/[oz] | 344/12.1 |
| Force factor [BI] | 5.2 |
| VAS [I] | 1.50 |
| Qes | 0.46 |
| Qts | 0.35 |

Lastly, the technical characteristics for the previously discussed tweeter 320 are also summarized below:

| | |
|---|---|
| Nominal impedance [ohm] | 6 |
| Voice coil resistance [ohm] | 4.6 |
| Nominal poser [W] | 200 |
| Short term max power [W] | 400 |
| Long term max power [W] | 200 |
| Operating Power | 5 |
| Sensitivity [dB] | 90 |
| Frequency range [Hz] | 3-22 |
| Free air resonance [Hz] | 1390 |
| Voice coil diameter [mm] | 25 |
| Voice coil height [mm] | 1.5 |
| Air gap height [mm] | 2 |
| Voice coil inductance [mH] | 0.05 |
| Eff. diaphragm Area [cm²] | 7.1 |
| Moving mass [g] | 0.31 |
| Magnet weight [g]/[oz] | 11/0.4 |
| Force factor [BI] | 1.85 |
| VAS [I] | 0.002 |
| Qms | 2.09 |
| Qes | 3.67 |
| Qts | 1.33 |

While this invention has been described with reference to illustrative embodiments, this description is not intended to be construed in a limiting sense. Various modifications of the illustrative embodiments, as well as other embodiments of the invention, which are apparent to persons skilled in the art to which the invention pertains are deemed to lie within the spirit and scope of the invention.

What is claimed is:

1. A speaker enclosure to mount and enclose a speaker driver, the speaker enclosure comprising:
a front mounting portion having an opening to mount the speaker driver; and
a body portion extending rearwardly from the front mounting portion, the speaker driver being enclosed by the front mounting portion and the body portion within an interior of the speaker enclosure;
wherein the body portion includes a liquid chamber, the liquid chamber being filled with a liquid to affect the tuning of the speaker enclosure and to enhance lower frequencies.

2. The speaker enclosure of claim 1, further comprising at least one baffle extending from the body portion into the interior to aid in transmitting sound waves from the speaker driver to the liquid chamber and to enhance lower frequencies.

3. The speaker enclosure of claim 2, wherein an amount of liquid to be included in the liquid chamber is pre-determined during a testing phase in order to affect a desired tuning of the speaker enclosure in combination with speaker driver and to enhance lower frequencies.

4. The speaker enclosure of claim 1, wherein the liquid is a gelatinous material.

5. The speaker enclosure of claim 4, wherein the gelatinous material is a hair gel.

6. The speaker enclosure of claim 1, wherein the front mounting portion and the body portion include an acrylic material.

7. The speaker enclosure of claim 1, further comprising a gasket, the speaker driver being mounted in the opening of the front mounting portion with the gasket such that the speaker enclosure is pressurized.

8. A speaker enclosure to mount and enclose a speaker driver, the speaker enclosure comprising:
a front mounting wall having an opening to mount the speaker driver;
a top wall and a bottom wall extending rearwardly from the front mounting wall; and
a pair of opposed side walls extending rearwardly from the front mounting wall between the top and bottom walls to a rear wall, the speaker driver being enclosed by the front, top, bottom and sidewalls within an interior of the speaker enclosure;
wherein at least the rear wall includes a liquid chamber, the liquid chamber being filled with a liquid to affect the tuning of the speaker enclosure.

9. The speaker enclosure of claim 8, further comprising at least one baffle extending from rear wall in the interior of the speaker enclosure towards the speaker driver, the baffle to aid in transmitting sound waves from the speaker driver to the liquid of the liquid chamber and to enhance lower frequencies.

10. The speaker enclosure of claim 8, wherein an amount of liquid to be included in the liquid chamber is pre-determined during a testing phase in order to affect a desired tuning of the speaker enclosure in combination with speaker driver and to enhance lower frequencies.

11. The speaker enclosure of claim 8, wherein the liquid is a gelatinous material.

12. The speaker enclosure of claim 11, wherein the gelatinous material is a hair gel.

13. The speaker enclosure of claim 8, further comprising a gasket, wherein the speaker driver is mounted in the opening of the front mounting wall with the gasket.

14. The speaker enclosure of claim 13, wherein the speaker enclosure is pressurized.

15. The speaker enclosure of claim 8, wherein the front mounting wall, the bottom wall, the top wall, the rear wall, and the opposed sidewalls include an acrylic material.

16. The speaker enclosure of claim 8, wherein the front mounting wall includes a semi-isobaric configuration in which a first section of the mounting wall is disposed at an approximately 45 degree angle relative to a second section of the mounting wall, wherein the first section of the mounting wall includes a first opening for mounting a first speaker driver and the second section of the mounting wall includes a second opening for mounting a second speaker driver.

17. A speaker enclosure to mount and enclose a speaker driver, the speaker enclosure comprising:
a front mounting wall having an opening to mount the speaker driver;
a top wall and a bottom wall extending rearwardly from the front mounting wall;
a pair of opposed side walls extending rearwardly from the front mounting wall between the top and bottom walls to a rear wall, the speaker driver being enclosed by the front, top, bottom and sidewalls within an interior of the speaker enclosure; and
at least one baffle extending from rear wall in the interior of the speaker enclosure towards the speaker driver;
wherein at least the rear wall includes a liquid chamber, the liquid chamber being filled with a liquid to affect the tuning of the speaker enclosure and the baffle aids in transmitting sound waves from the speaker driver to the liquid of the liquid chamber and to enhance lower frequencies.

18. The speaker enclosure of claim 17, wherein an amount of liquid to be included in the liquid chamber is pre-determined during a testing phase in order to affect a desired tuning of the speaker enclosure in combination with speaker driver and to enhance lower frequencies.

19. The speaker enclosure of claim 18, wherein the liquid is a gelatinous material.

20. The speaker enclosure of claim 19, wherein the gelatinous material is a hair gel.

21. The speaker enclosure of claim 17, wherein the front mounting wall, the bottom wall, the top wall, the rear wall, and the opposed sidewalls include an acrylic material.

22. The speaker enclosure of claim 17, further comprising a gasket, the speaker driver being mounted in opening of the front mounting wall with the gasket such that the speaker enclosure is pressurized.

23. The speaker enclosure of claim 17, wherein the front mounting wall includes a semi-isobaric configuration in which a first section of the mounting wall is disposed at an approximately 45 degree angle relative to a second section of the mounting wall, wherein the first section of the mounting wall includes a first opening for mounting a first speaker driver and the second section of the mounting wall includes a second opening for mounting a second speaker driver.

24. A speaker system comprising:
a speaker driver; and
a speaker housing comprising:
a front mounting wall having an opening to mount the speaker driver;
a top wall and a bottom wall extending rearwardly from the front mounting wall;
a pair of opposed side walls extending rearwardly from the front mounting wall between the top and bottom walls to a rear wall, the speaker driver being enclosed by the front, top, bottom and sidewalls within an interior of the speaker enclosure;
at least one baffle extending from rear wall in the interior of the speaker enclosure towards the speaker driver; and
a gasket, the speaker driver being mounted in opening of the front mounting with the gasket such that the speaker enclosure is pressurized;
wherein at least the rear wall includes a liquid chamber, the liquid chamber being filled with a liquid to affect the tuning of the speaker enclosure and the baffle aids in transmitting sound waves from the speaker driver to the liquid of the liquid chamber and to enhance lower frequencies.

25. The speaker system of claim 24, wherein an amount of liquid to be included in the liquid chamber is pre-determined during a testing phase in order to affect a desired tuning of the speaker enclosure in combination with speaker driver and to enhance lower frequencies.

26. The speaker system of claim 25, wherein the liquid is a gelatinous material.

27. The speaker system of claim 26, wherein the gelatinous material is a hair gel.

28. The speaker system of claim 24, wherein the front mounting wall, the bottom wall, the top wall, the rear wall, and the opposed sidewalls include an acrylic material.

29. The speaker system of claim 24, further comprising a gasket, the speaker driver being mounted in opening of the front mounting wall with the gasket such that the speaker enclosure is pressurized.

30. The speaker system of claim 24, wherein the front mounting wall includes a semi-isobaric configuration in which a first section of the mounting wall is disposed at an approximately 45 degree angle relative to a second section of the mounting wall, wherein the first section of the mounting wall includes a first opening for mounting a first speaker driver and the second section of the mounting wall includes a second opening for mounting a second speaker driver.
